(19) United States
(12) Patent Application Publication
(10) Pub. No.: US 2017/0192099 A1
(43) Pub. Date: Jul. 6, 2017

(54) APPARATUS AND METHOD FOR REDUCING HARMONIC INTERFERENCE TO GPS SIGNAL RECEPTION

(71) Applicant: AIROHA TECHNOLOGY CORP., HSINCHU (TW)

(72) Inventors: HENG-CHIH LIN, HSINCHU (TW); WEN-SHENG HOU, HSINCHU (TW); CHIEN-CHEN LIN, HSINCHU (TW)

(21) Appl. No.: 14/988,857

(22) Filed: Jan. 6, 2016

(51) Int. Cl. G01S 19/21

(52) U.S. Cl. CPC G01S 19/21

(57) ABSTRACT

The present invention provides an apparatus and method for reducing harmonic interference to GPS signal reception. The apparatus comprises a RF transceiver module, a GPS signal reception path, and a harmonic distortion predictor. The RF transceiver module generates a first signal to be transmitted. The harmonic distortion predictor is used for establishing an estimated harmonic distortion sample based on the first signal. The GPS signal reception path receives an analog GPS signal, and converts the analog GPS signal into a digital GPS signal. The digital GPS signal subtracts the estimated harmonic distortion sample to obtain an accurate digital GPS signal. Thereby, the harmonic interference may be eliminated from the GPS signal in digital domain by means of digitally form so as to reduce distortion of the GPS signal.

### CROSS-REFERENCE TO RELATED APPLICATIONS

This non-provisional application claims priority claim under 35 U.S.C. §119(a) on Taiwan Patent Application No. 104105463 filed Feb. 17, 2015, the entire contents of which are incorporated herein by reference.

### FIELD OF THE INVENTION

The present invention is related to an apparatus and method for reducing harmonic interference to GPS signal, particularly to an apparatus and method for eliminating harmonic interference to GPS signal in digital domain digitally.

### BACKGROUND

As the trend develops, more and more communication functions are integrated in one single wireless communication device. For instance, a radio frequency (RF) transceiver and a global positioning system (GPS) receiver are integrated in a wireless communication device simultaneously. In this wireless communication device, the RF transceiver is used to communicate with a base station wirelessly via RF signal, while the GPS receiver is used to receive GPS signal. The GPS receiver is allowed to receive GPS signal to perform satellite-based positioning with GPS continuously, while the RF transceiver of the wireless communication device receives or transmits RF signal.

When RF signal is transmitted by the RF transceiver, however, the transmitted RF signal is prone to leak to a reception path of the GPS receiver. In case the frequency of harmonics of the leaking signal just falls within the receiving band of the GPS receiver, co-channel harmonics may interfere with the GPS receiver. Then, distortion of the GPS signal received by the GPS receiver may be generated, and satellite-based positioning with GPS of the wireless communication device may be thus affected.

In view of the fact, the present invention provides an apparatus and method for reducing harmonics inference to GPS signal reception, having the capability of avoiding the influence of voice communication of wireless communication device on satellite-based positioning with GPS, which will be the object of the present invention.

### SUMMARY

It is one object of the present invention to provide a method for reducing harmonic interference to GPS signal reception, the method being applied to a wireless communication device and predicting harmonic distortion generated due to voice communication of the wireless communication device so as to establish an estimated harmonic distortion sample. When voice communication and satellite-based positioning with GPS are performed by the wireless communication device simultaneously, the estimated harmonic distortion sample may be subtracted from the received GPS signal, thereby reducing distortion of GPS signal caused by harmonic interference. Thus, the wireless communication device is allowed for precise satellite-based positioning.

It is another object of the present invention to provide an apparatus and method for reducing harmonic interference to GPS signal reception, in which a wireless communication device is capable of generating a RF signal to be transmitted in advance before the GPS signal is received, such that an estimated harmonic distortion sample is established by means of this RF signal to be transmitted.

It is another object of the present invention to provide an apparatus and method for reducing harmonic interference to GPS signal reception, in which a wireless communication device is capable of generating a RF signal to be transmitted in advance and conducting a test on at least one surface acoustic wave filter in a GPS signal reception path for characteristics, so as to verify at least one characteristic parameter of the surface acoustic wave filter. Thereby, the RF signal to be transmitted and the characteristic parameter of the surface acoustic wave filter are used to establish an estimated harmonic distortion sample.

It is another object of the present invention to provide an apparatus and method for reducing harmonic interference to GPS signal reception, in which a minimum error algorithm is used to calculate with respect to an error signal between the GPS signal and the estimated harmonic distortion sample so as to obtain an algorithmic result. The result of minimum error algorithm is used to adjust the estimated harmonic distortion sample, such that the estimated harmonic distortion sample is possibly adjusted adaptively to be more precise so as to further reduce distortion of GPS signal.

For achieving above objects, the present invention provides an apparatus for reducing harmonic interference to GPS signal reception, comprising: a RF transceiver module, generating a first signal to be transmitted; a GPS signal reception path, comprising a low noise amplifier, a GPS signal processor and an analog-to-digital converter, the low noise amplifier, the GPS signal processor and the analog-to-digital converter are connected in turn, wherein an amplified analog GPS signal is received by the GPS signal processor via the low noise amplifier, the analog-to-digital converter converting the analog GPS signal into a digital GPS signal; and a harmonic distortion predictor, connected to the RF transceiver module and the GPS signal reception path, configured to establish an estimated harmonic distortion sample by the use of the first signal digitally, the estimated harmonic distortion sample being subtracted from the digital GPS signal, such that the harmonic interference is eliminated from the digital GPS signal in digital domain digitally so as to reduce distortion of the digital GPS signal.

In one embodiment of the present invention, wherein the digital GPS signal is a GPS signal distorted due to harmonic interference, the harmonic interference being induced by leaking signal generated when the first signal is transmitted by the RF transceiver module.

In one embodiment of the present invention, wherein the GPS signal reception path further comprises one or more surface acoustic wave filters, connected to the input of the low noise amplifier and/or the output of the low noise amplifier.

In one embodiment of the present invention, further comprising a verification unit, provided between the GPS signal reception path and the harmonic distortion predictor, configured to test on the surface acoustic wave filter for characteristics so as to verify at least one characteristic parameter of the surface acoustic wave filter, wherein the estimated harmonic distortion sample is established by the harmonic distortion predictor digitally by means of the first signal and the characteristic parameter of the surface acoustic filter.

In one embodiment of the present invention, further comprising a minimum error algorithmic unit, connected to the GPS signal reception path and the harmonic distortion predictor, wherein the minimum error algorithmic unit is allowed to acquire an error signal between the digital GPS signal and the estimated harmonic distortion sample, and then calculate with respect to the error signal so as to obtain at least one weight value, the weight value being used to adjust operational coefficients of the harmonic distortion predictor so as to adjust the estimated harmonic distortion sample.

In one embodiment of the present invention, wherein the minimum error algorithmic unit is capable of executing the process of minimum error algorithm repeatedly until the error signal converges.

In one embodiment of the present invention, wherein the minimum error algorithmic unit is a least mean square (LMS) algorithmic unit, a mean square error (MSE) algorithmic unit, a recursive least square (RLS) algorithmic unit, or an algorithmic unit used for minimizing error signal.

In one embodiment of the present invention, further comprising a digital estimating algorithmic unit, connected to the GPS signal reception path and the harmonic distortion predictor, wherein the digital estimating algorithmic unit is allowed for estimating output energy or signal variation of the digital GPS signal so as to obtain an estimating signal, the estimating signal being used to adjust operational coefficients of the harmonic distortion predictor so as to adjust the estimated harmonic distortion sample.

In one embodiment of the present invention, wherein the digital estimating algorithmic unit is a minimum output energy (MOE) algorithmic unit or a minimum variance unbiased (MVU) estimating algorithmic unit.

In one embodiment of the present invention, wherein the harmonic distortion predictor is a Volterra digital filter, an adaptive digital filter, or a digital filter capable of generating the estimated harmonic distortion sample digitally.

In one embodiment of the present invention, wherein the RF transceiver module is connected to a first antenna, the RF transceiver module communicating with a base station wirelessly via the first antenna, and the GPS signal reception path is connected to a second antenna, the GPS signal reception path receiving the analog GPS signal transmitted by a satellite via the second antenna.

In one embodiment of the present invention, wherein an antenna is shared by the RF transceiver module and the GPS signal reception path, the RF transceiver module communicating with a base station wirelessly via the antenna, while the GPS signal reception path receiving the analog GPS signal transmitted by a satellite via the antenna.

In one embodiment of the present invention, wherein the RF transceiver module and the GPS signal reception path are connected to the antenna via a duplexer.

The present invention another provides a method for reducing harmonic interference to GPS signal reception, the method being applied to GPS signal reception of a wireless communication device, comprising the steps of: executing a process of establishing an estimated harmonic distortion sample, comprising: generating a first signal to be transmitted; and inputting the first signal to a harmonic distortion predictor so as to establish an estimated harmonic distortion sample digitally; and executing a process of GPS signal reception, comprising: receiving an analog GPS signal; converting the analog GPS signal into a digital GPS signal; and subtracting the estimated harmonic distortion sample from the digital GPS signal in digital domain digitally, so as to reduce distortion of the digital GPS signal.

In one embodiment of the present invention, wherein executing the process of establishing the estimated harmonic distortion sample further comprises a step of: testing on a surface acoustic wave filter in a GPS signal reception path for characteristics, so as to verify at least one characteristic parameter of the surface acoustic wave filter.

In one embodiment of the present invention, wherein executing the process of establishing the estimated harmonic distortion sample further comprises a step of: inputting the first signal and the characteristic parameter of the surface acoustic filter to the harmonic distortion predictor, so as to establish the estimated harmonic distortion sample digitally.

In one embodiment of the present invention, wherein executing the process of establishing the estimated harmonic distortion sample further comprises executing a process of minimum error algorithm, comprising: acquiring an error signal between the digital GPS signal and the estimated harmonic distortion sample; calculating with respect to the error signal by means of a minimum error algorithm so as to obtain a weight value; and adjusting operational coefficients of the harmonic distortion predictor by the use of the weight value, so as to adjust the estimated harmonic distortion sample.

In one embodiment of the present invention, wherein the process of minimum error algorithm is executed repeatedly until the error signal converges.

In one embodiment of the present invention, wherein the minimum error algorithm is a least mean square (LMS) algorithm, a mean square error (MSE) algorithm, a recursive least square (RLS) algorithm, or an algorithm used for minimizing error signal.

In one embodiment of the present invention, wherein executing the process of establishing the estimated harmonic distortion sample further comprises executing a process of digital estimating algorithm, comprising: estimating output energy or signal variation of the digital GPS signal so as to obtain an estimating signal by means of a digital estimating algorithm; and adjusting operational coefficients of the harmonic distortion predictor so as to adjust the estimated harmonic distortion sample by the use of the estimating signal.

In one embodiment of the present invention, wherein the digital estimating algorithm is a minimum output energy (MOE) algorithm or a minimum variance unbiased (MVU) estimating algorithm.

### BRIEF DESCRIPTION OF THE DRAWINGS

FIG. 1 is a structural diagram of a wireless communication device according to one embodiment of the present invention.

FIG. 2 is a structural diagram of a wireless communication device according to yet another embodiment of the present invention.

FIG. 3 is a structural diagram of a wireless communication device according to yet another embodiment of the present invention.

FIG. 4 is a structural diagram of a wireless communication device according to yet another embodiment of the present invention.

FIG. 5 is a structural diagram of a wireless communication device according to yet another embodiment of the present invention.

FIG. 6 is a structural diagram of a wireless communication device according to yet another embodiment of the present invention.

FIG. 7 is a structural diagram of a wireless communication device according to yet another embodiment of the present invention.

FIG. 8 is a flow chart of a method for reducing harmonic interference to GPS signal reception according to one embodiment of the present invention.

FIG. 9 is a flow chart of a process of minimum error algorithm of a method of the present invention.

FIG. 10 is a flow chart of a method for reducing harmonic interference to GPS signal reception according to yet another embodiment of the present invention.

FIG. 11 is a flow chart of a method for reducing harmonic interference to GPS signal reception according to yet another embodiment of the present invention.

### DETAILED DESCRIPTION OF THE PREFERRED EMBODIMENTS

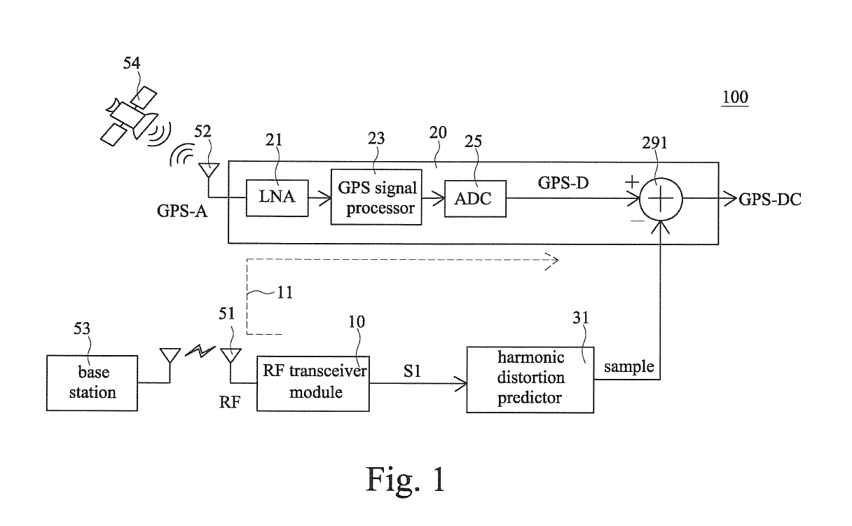

Referring to FIG. 1, there is shown a structural diagram of a wireless communication device according to one embodiment of the present invention. The wireless communication device 100 of the present invention may be a cellular mobile telephone or a smartphone, which comprises a radio frequency (RF) transceiver module 10 and a global positioning system (GPS) signal reception path 20. The RF transceiver module 10 is connected to a first antenna 51 so as to communicate wirelessly with a base station 53 via the first antenna 51. Moreover, the GPS signal reception path 20 is connected to a second antenna 52 so as to receive an analog GPS signal (GPS-A) transmitted by a satellite 54 via the second antenna 52.

In this case, the RF transceiver module 10 is allowed to transmit RF signal to the base station 53 via the first antenna 51, or to receive RF signal transmitted by the base station 53 via the first antenna 51.

The GPS signal reception path 20 comprises a low noise amplifier (LNA) 21, a GPS signal processor 23 and an analog-to-digital converter (ADC) 25. The GPS signal processor 23 is connected to the low noise amplifier 21, so as to receive an amplified analog signal (GPS-A) via the second antenna 52 and the low noise amplifier 21. The ADC 25 is connected to the GPS signal processor 23, for converting the GPS signal (GPS-A) into digital form from analog form. Thereby, a digital GPS signal (GPS-D) is obtained.

Further, when RF signal is transmitted by the RF transceiver module 10, the transmitted signal (such as a TX leaking signal 11) is prone to leak to the GPS signal reception path 20. Therefore, when the GPS signal is received by the GPS signal reception path 20 via the second antenna 52, the TX leaking signal 11 may be received by the GPS signal reception path 20 at the same time. If harmonics of the TX leaking signal 11 just falls into the receiving frequency band of the GPS signal reception path 20 exactly, the co-channel harmonics may cause interference to the GPS signal received by the GPS signal reception path 20, resulting in distortion of GPS signal.

Accordingly, for the reduction of harmonic interference, generated when RF signal is transmitted by the RF transceiver module 10, to GPS signal reception, the present invention provides a mechanism for reducing harmonic interference to GPS signal reception. The operation process of the mechanism is described as follows.

The wireless communication device 100 of the present invention may further comprise a harmonic distortion predictor 31 connected to the RF transceiver module 10. The RF transceiver module 10 is allowed to generate a first signal to be transmitted (S1) in advance, before the GPS signal is received by the GPS signal reception path 20. This first signal Si is a RF signal or a down-converted baseband signal. The first signal (S1) is inputted to the harmonic distortion predictor 31 by the RF transceiver module 10.

The harmonic distortion predictor 31 is allowed to receive the first signal (S1), and then establish an estimated harmonic distortion sample digitally on the basis of the first signal (S1). After the estimated harmonic distortion sample is established, in case GPS signal reception is performed by the GPS signal reception path 20 subsequently, the estimated harmonic distortion sample may be subtracted from the digital GPS signal (GPS-D) (For instance, the estimated harmonic distortion sample is subtracted from the digital GPS signal (GPS-D) by means of an adder 291.), in such a way that a digital GPS signal with reduced distortion (GPS-DC) is obtained. Afterwards, a demodulator may be used by the wireless communication device 100 to demodulate the digital GPS signal (GPS-DC) for precise satellite-based positioning with GPS. In this way, harmonic interference is eliminated digitally in the GPS signal (GPS-DC) in digital domain, and distortion of GPS signal (GPS-DC) is then reduced.

As the above approach is embodied, when voice communication and satellite-based positioning with GPS are performed by the wireless communication device 100 simultaneously, the harmonic interference, generated due to voice communication, in the GPS signal reception path 20 may be reduced effectively. Then, the wireless communication device 100 is capable of performing satellite-based positioning with GPS precisely.

Further, the harmonic distortion predictor 31 of the present invention may be a Volterra digital filter, an adaptive digital filter, or a digital filter capable of generating harmonic distortion sample digitally.

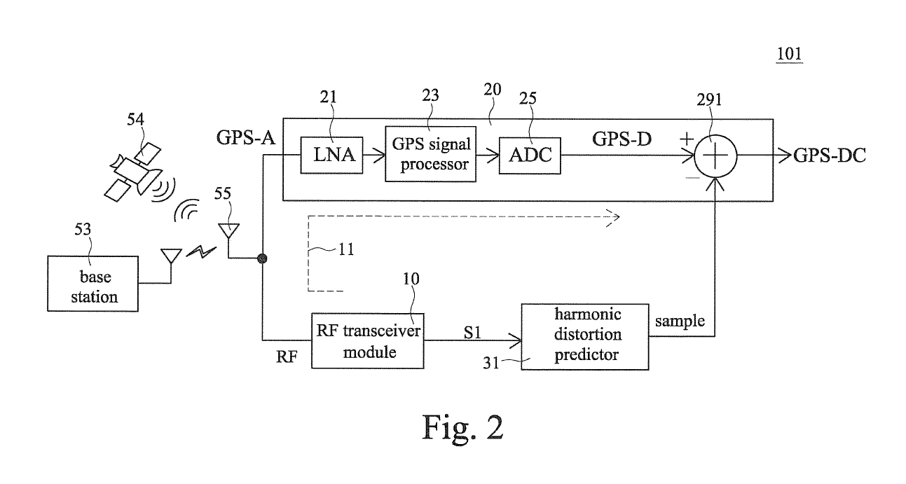

Referring to FIG. 2, there is shown a structural diagram of a wireless communication device according to another embodiment of the present invention. In this embodiment, wireless transmission between the RF transceiver module 10 as well as the GPS signal reception path 20 of the wireless communication device 101, and the base station 53 as well as the satellite 54 may be performed via a common antenna 55, respectively. In this connection, one single antenna 55 shared by the RF transceiver module 10 and the GPS signal reception path 20 is effective to diminish the circuit area of the wireless communication device 101. In the subsequent embodiments, respective antennas 51, 52 or one common antenna 55 may be selected for the RF transceiver module 10 and the GPS signal reception path 20, without being expounded again herein.

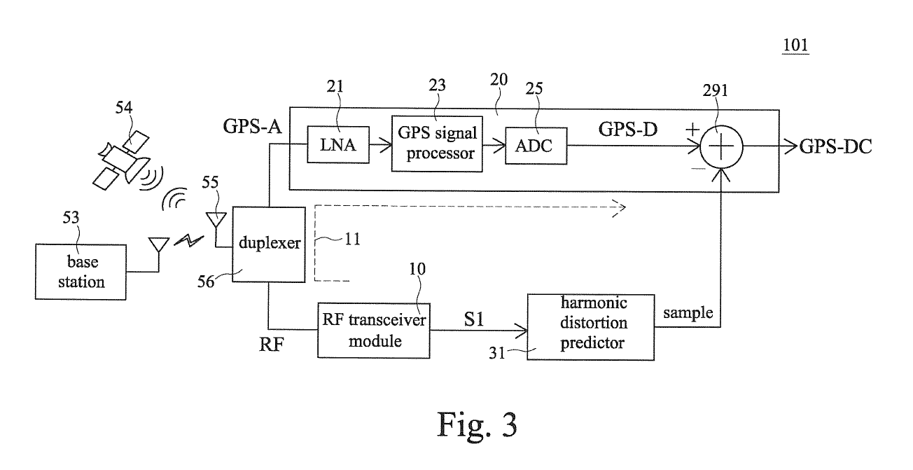

Further, in another embodiment of the present invention, as illustrated in FIG. 3, the antenna 55 may be shared by the RF transceiver module 10 and the GPS signal reception path 20 via a duplexer 56. Thereby, the transmission of RF signal and receiving GPS signal are performed via the duplexer 56.

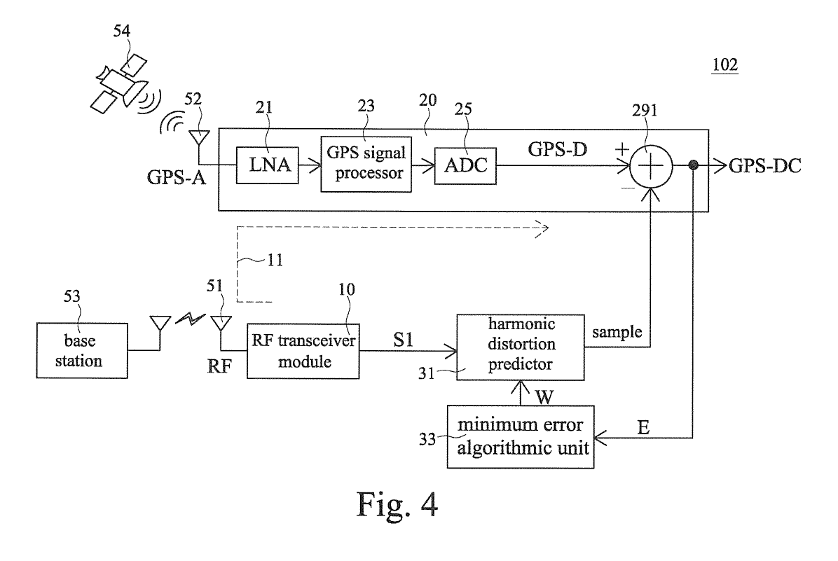

Referring to FIG. 4, there is shown a structural diagram of a wireless communication device according to another embodiment of the present invention. The wireless communication device 102 of this embodiment further comprises a minimum error algorithmic unit 33 connected to the GPS signal reception path 20 and the harmonic distortion predictor 31. An error signal (E) between the digital GPS signal (GPS-D) and the estimated harmonic distortion sample is acquired by the minimum error algorithmic unit 33 and then to be calculated, such that at least one weight value (W) is obtained. The operational coefficients of the harmonic distortion predictor 31 may be adjusted by means of the weight value (W) so as to adjust the estimated harmonic distortion sample. In this connection, algorithm for minimizing the error signal (E) is executed by the minimum error algorithmic unit 33, in such a way that the estimated harmonic distortion sample may be adjusted adaptively to be more precise and then allowed to further reduce distortion of digital GPS signal (GPS-DC). In addition, the process of minimum error algorithm will be executed repeatedly until the error signal (E) converges. For instance, the error signal (E) converges towards a constant. Further, the minimum error algorithmic unit 33 described in the present invention may be a least mean square (LMS) algorithmic unit, a mean square error (MSE) algorithmic unit, a recursive least square (RLS) algorithmic unit, or an algorithmic unit used for minimizing the error signal (E).

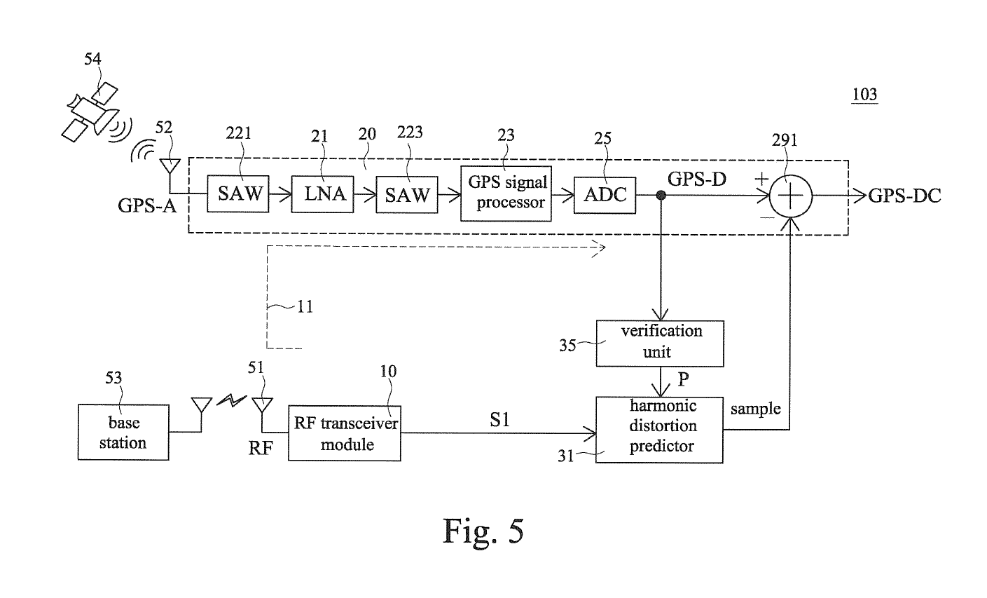

Referring to FIG. 5, there is shown a structural diagram of a wireless communication device according to another embodiment of the present invention. In comparison with the embodiment in FIG. 1, the GPS signal reception path 20 of the wireless communication device 103 further comprises at least one surface acoustic wave (SAW) filter 221/223.

In one embodiment of the present invention, the GPS signal reception path 20 may include only one single surface acoustic wave filter 221/223, the single surface acoustic wave filter 221 possibly being provided between the input of the low noise amplifier 21 and the second antenna 52, or the single surface acoustic wave filter 223 selectively provided between the output of the low noise amplifier 21 and the GPS signal processor 23. In another embodiment of the present invention, otherwise, the GPS signal reception path 20 may comprise two surface acoustic wave filters 221, 223, provided between the input of the low noise amplifier 21 and the second antenna 52, as well as between the output of the low noise amplifier 21 and the GPS signal processor 23, respectively. Then, the out-of-band signal with respect to the analog GPS signal (GPS-A) may be filtered out by means of the surface acoustic wave filter 221/223.

Furthermore, the wireless communication device 103 of this embodiment further comprises a verification unit 35 provided between the GPS signal reception path 20 and the harmonic distortion predictor 31. Likewise, before the GPS signal is received by the GPS signal reception path 20, the verification unit 35 is allowed to conduct a test on the surface acoustic wave filter 221/223 in the GPS signal reception path 20 for characteristics (for example, amplitude, wave speed, phase, mid-frequency, and etc.) in advance. In one embodiment of the present invention, some test data is used by the verification unit 35 to test for the characteristics of the surface acoustic wave filter 221/223, so as to verify at least one characteristic parameter (P) of the surface acoustic wave filter, such as, amplitude, wave speed, phase, mid-frequency, and etc. In another embodiment of the present invention, otherwise, an external test equipment may be used, during the manufacturing process of the wireless communication device 103, to conduct the test on the surface acoustic wave filter 221/223 for characteristics, so as to store the characteristic parameter (P) of the surface acoustic wave filter, obtained from the test, into the verification unit 35 directly. Further, after the characteristic parameter (P) of the surface acoustic wave filter is verified by the verification unit 35, the characteristic parameter (P) of the surface acoustic wave filter is inputted to the harmonic distortion predictor 31.

In this embodiment, the harmonic distortion predictor 31 is allowed to receive the first signal (S1) and the characteristic parameter (P) of the surface acoustic wave filter, and then establish the estimated harmonic distortion sample on the basis of the first signal (S1) and the characteristic parameter (P) of the surface acoustic wave filter. This estimated harmonic distortion sample will react to transmitted wave distortion of the RF transceiver module 10 due to linear or nonlinear factors, and react to variation in characteristics of the surface acoustic wave filter 221/223 due to factors, such as manufacturing process or temperature, and etc.

After the estimated harmonic distortion sample is established, in case GPS signal reception is performed by the GPS signal reception path 20 subsequently, the estimated harmonic distortion sample may be subtracted from the digital GPS signal (GPS-D) (For instance, the estimated harmonic distortion sample is subtracted from the digital GPS signal (GPS-D) by means of the adder 291.), in such a way that the digital GPS signal (GPS-D) with reduced distortion (GPS-DC) is obtained. Afterwards, a demodulator may be used by the wireless communication device 103 to demodulate the digital GPS signal (GPS-DC) for precise satellite-based positioning with GPS. In this connection, the characteristic parameter (P) of the surface acoustic wave filter is further taken into consideration by the harmonic distortion sample generated by the harmonic distortion predictor 31 of this embodiment, such that the harmonic distortion sample is more close to the operational environment where the GPS signal is received practically.

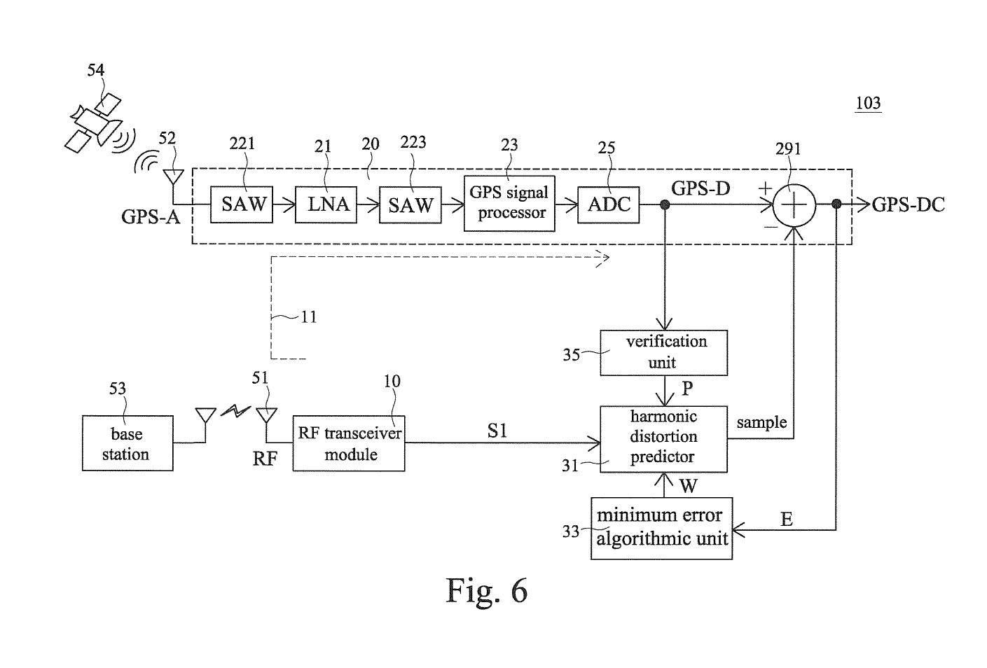

As illustrated in FIG. 6, naturally, the wireless communication device 103 in another embodiment of the present invention is further provided with a minimum error algorithmic unit 33. Algorithm for minimizing the error signal (E) is executed by the minimum error algorithmic unit 33, in such a way that the estimated harmonic distortion sample may be adjusted adaptively to be more precise and then allowed to further reduce distortion of digital GPS signal (GPS-DC).

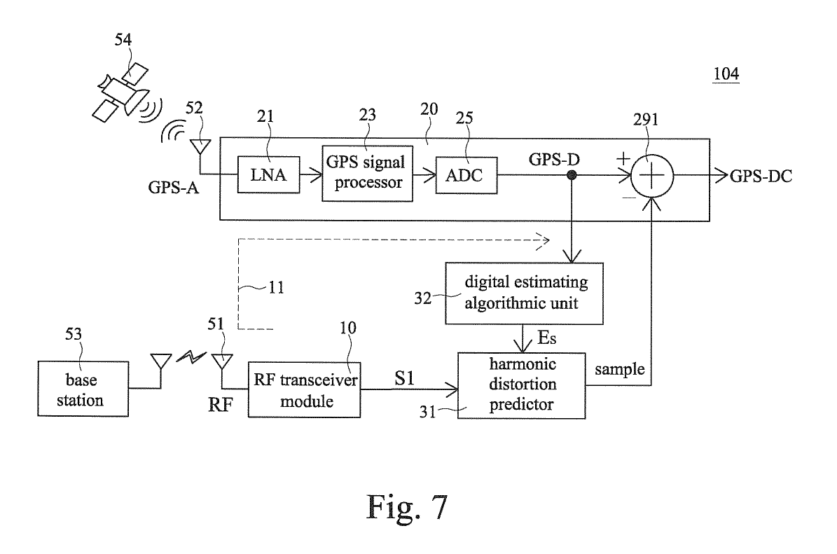

Referring to FIG. 7, there is shown a structural diagram of a wireless communication device according to another embodiment of the present invention. In comparison with the embodiment in FIG. 1, the wireless communication device 104 of this embodiment further comprises a digital estimating algorithmic unit 32 connected to the GPS signal reception path 20 and the harmonic distortion predictor 31. The digital estimating algorithmic unit 32 is used for estimating output energy or signal variation of the digital GPS signal (GPS-D), so as to obtain an estimating signal (Es). Moreover, the estimating signal (Es) is used to adjust operational coefficients of the harmonic distortion predictor 31, so as to adjust the estimated harmonic distortion sample. Further, the digital estimating algorithmic unit 32 described in the present invention may be a minimum output energy (MOE) algorithmic unit or a minimum variance unbiased (MVU) estimating algorithmic unit.

In this connection, the signal characteristics presented in the digital GPS signal (GPS-D) is estimated by the digital estimating algorithmic unit 32, such that the estimated harmonic distortion sample is adjusted on the basis of this estimated result. Thus, the estimated harmonic distortion sample is capable of being adjusted in consideration of actual signal variation in the digital GPS signal (GPS-D).

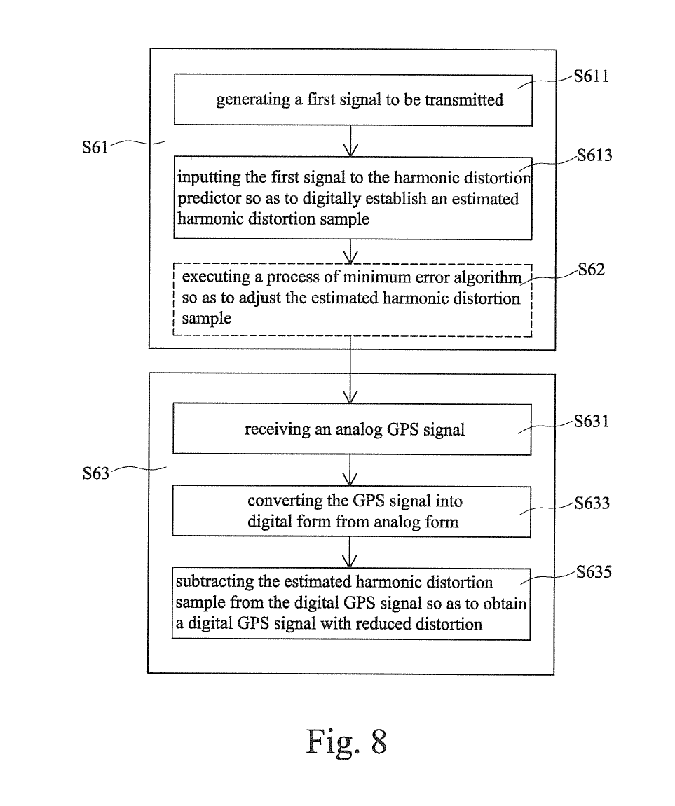

Referring to FIG. 8, there is shown a flow chart of a method for reducing harmonic interference to GPS signal reception according to one embodiment of the present invention. Firstly, in step S61, a process of establishing an estimated harmonic distortion sample is executed. In the step of process of establishing the estimated harmonic distortion sample, generating a first signal to be transmitted (S1) by the RF transceiver module 10 is executed in step S611. In step S613, the first signal (S1) is inputted to the harmonic distortion predictor 31, such that an estimated harmonic distortion sample is established by the harmonic distortion predictor 31 digitally.

Subsequently, in step S63, a process of receiving GPS signal is executed. In step S631, an analog GPS signal (GPS-A) is received by the GPS signal reception path 20 via the antenna from the satellite. In step S633, the GPS signal (GPS-A) is converted into digital form from analog form, such that a digital GPS signal (GPS-D) is obtained. Finally, in step S635, the estimated harmonic distortion sample is subtracted from the digital GPS signal (GPS-D), in such a way that a digital GPS signal with reduced distortion (GPS-DC) is obtained.

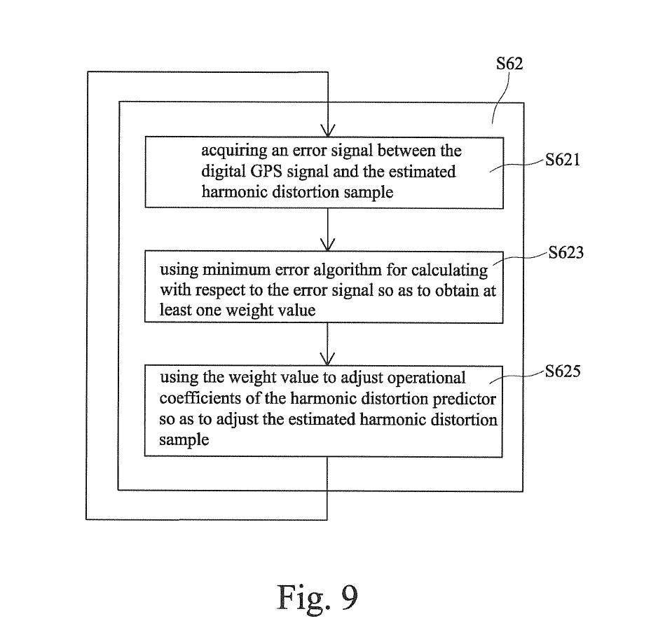

In another embodiment of the present invention, step S61 of the process of establishing the estimated harmonic distortion sample further comprises step S62 of executing a process of minimum error algorithm. As illustrated in FIG. 9, in the step of process of minimum error algorithm, acquiring an error signal (E) between the digital GPS signal (GPS-D) and the estimated harmonic distortion sample by the minimum error algorithmic unit 33 is executed in step S621. In step S623, the minimum error algorithmic unit 33 is allowed to use a minimum error algorithm for calculating with respect to the error signal (E) so as to obtain at least one weight value (W). In step S625, the weight value (W) is used by the minimum error algorithmic unit 33 to adjust operational coefficients of the harmonic distortion predictor 31 so as to adjust the estimated harmonic distortion sample. Afterwards, in step S635, the adjusted estimated harmonic distortion sample is subtracted from the digital GPS signal (GPS-D), such that distortion of digital GPS signal (GPS-DC) is further reduced. Further, the process of minimum error algorithm will be executed repeatedly until the error signal (E) converges.

Further, the minimum error algorithm of the present invention is a least mean square (LMS) algorithm, a mean square error (MSE) algorithm, a recursive least square (RLS) algorithm, or an algorithm used for minimizing the error signal (E).

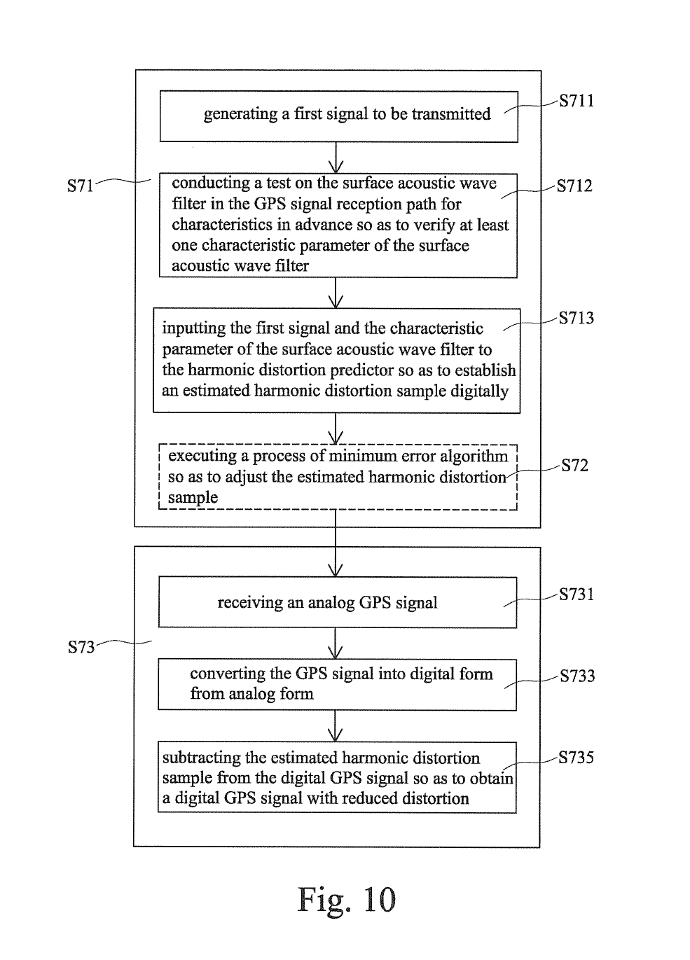

Referring to FIG. 10, there is shown a flow chart of a method for reducing harmonic interference to GPS signal reception according to yet another embodiment of the present invention. Firstly, in step S71, a process of establishing an estimated harmonic distortion sample is executed. In step S711, a first signal to be transmitted (S1) is generated by the RF transceiver module 10. In step S712, the verification unit 35 is allowed to conduct a test on the surface acoustic wave filter 221/223 in the GPS signal reception path 20 for characteristics in advance, so as to verify at least one characteristic parameter (P) of the surface acoustic wave filter. In step S713, the first signal (S1) and the characteristic parameter (P) of the surface acoustic wave filter are inputted to the harmonic distortion predictor 31, such that the harmonic distortion predictor 31 is allowed to establish an estimated harmonic distortion sample digitally.

Subsequently, in step S73, a process of receiving GPS signal is executed. In step S731, an analog GPS signal (GPS-A) is received by the GPS signal reception path 20 via the antenna from the satellite. In step S733, the GPS signal (GPS-A) is converted into digital form from analog form, such that a digital GPS signal (GPS-D) is obtained. Finally, in step S735, the estimated harmonic distortion sample is subtracted from the digital GPS signal (GPS-D), in such a way that a digital GPS signal with reduced distortion (GPS-DC) is obtained.

Further, in another embodiment of the present invention, step S71, executing a process of establishing the estimated harmonic distortion sample, further comprises step S72 of executing a process of minimum error algorithm. In step S72, algorithm for minimizing the error signal (E) is executed by minimum error algorithm used by the minimum error algorithmic unit 33, in such a way that the estimated ha ionic distortion sample may be adjusted adaptively to be more precise.

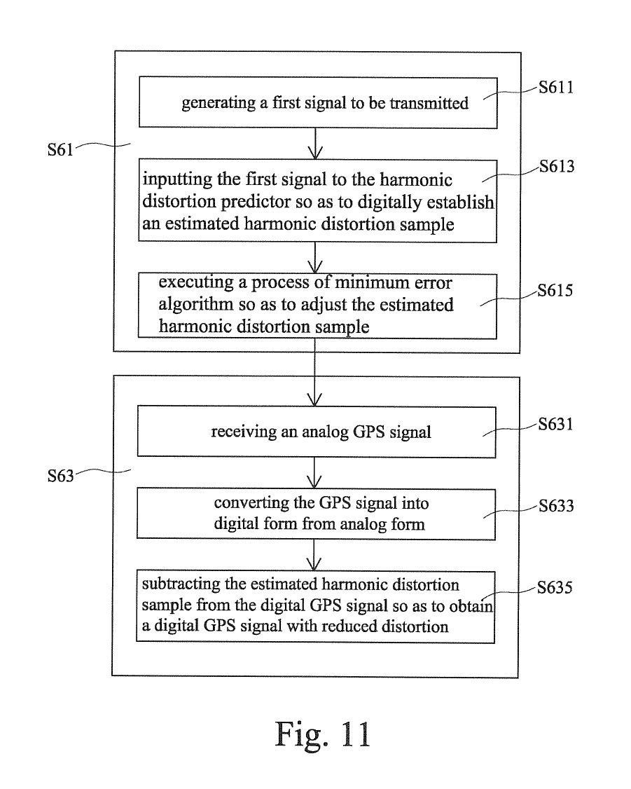

Referring to FIG. 11, there is shown a flow chart of a method for reducing harmonic interference to GPS signal reception according to another embodiment of the present invention. Firstly, in step S61, a process of establishing an estimated harmonic distortion sample is executed. In step S611, a first signal to be transmitted (S1) is generated by the RF transceiver module 10. In step S613, the first signal (S1) is inputted to the harmonic distortion predictor 31, such that an estimated harmonic distortion sample is established by the harmonic distortion predictor 31 digitally. In step S615, the digital estimating algorithmic unit 32 is allowed to use a digital estimating algorithm to estimate output energy or signal variation of the digital GPS signal (GPS-D) so as to obtain an estimating signal (Es), and the estimating signal (Es) is used to adjust operational coefficients of the harmonic distortion predictor 31, so as to adjust the estimated harmonic distortion sample. Further, the digital estimating algorithm described in the present invention is a minimum output energy (MOE) algorithm or a minimum variance unbiased (MVU) estimating algorithm.

Subsequently, in step S63, a process of receiving GPS signal is executed. In step S631, an analog GPS signal (GPS-A) is received by the GPS signal reception path 20 via the antenna from the satellite. In step S633, the GPS signal (GPS-A) is converted into digital form from analog form, such that a digital GPS signal (GPS-D) is obtained. Finally, in step S635, the estimated harmonic distortion sample is subtracted from the digital GPS signal (GPS-D), in such a way that a digital GPS signal with reduced distortion (GPS-DC) is obtained.

The above disclosure is only the preferred embodiment of the present invention, and not used for limiting the scope of the present invention. All equivalent variations and modifications on the basis of shapes, structures, features and spirits described in claims of the present invention should be included in the claims of the present invention.

What is claimed is:

1. An apparatus for reducing harmonic interference to GPS signal reception, comprising:
a RF transceiver module, generating a first signal to be transmitted;
a GPS signal reception path, comprising a low noise amplifier, a GPS signal processor and an analog-to-digital converter, said low noise amplifier, said GPS signal processor and said analog-to-digital converter are connected in turn, wherein an amplified analog GPS signal is received by said GPS signal processor via said low noise amplifier, said analog-to-digital converter converting said analog GPS signal into a digital GPS signal; and
a harmonic distortion predictor, connected to said RF transceiver module and said GPS signal reception path, configured to establish an estimated harmonic distortion sample by the use of said first signal digitally, said estimated harmonic distortion sample being subtracted from said digital GPS signal, such that the harmonic interference is eliminated from said digital GPS signal in digital domain digitally so as to reduce distortion of said digital GPS signal.

2. The apparatus according to claim 1, wherein said digital GPS signal is a GPS signal distorted due to harmonic interference, said harmonic interference being induced by leaking signal generated when said first signal is transmitted by said RF transceiver module.

3. The apparatus according to claim 1, wherein said GPS signal reception path further comprises one or more surface acoustic wave filters, connected to the input of said low noise amplifier and/or the output of said low noise amplifier.

4. The apparatus according to claim 3, further comprising a verification unit, provided between said GPS signal reception path and said harmonic distortion predictor, configured to test on said surface acoustic wave filter for characteristics so as to verify at least one characteristic parameter of said surface acoustic wave filter, wherein said estimated harmonic distortion sample is established by said harmonic distortion predictor digitally by means of said first signal and said characteristic parameter of said surface acoustic filter.

5. The apparatus according to claim 1, further comprising a minimum error algorithmic unit, connected to said GPS signal reception path and said harmonic distortion predictor, wherein said minimum error algorithmic unit is allowed to acquire an error signal between said digital GPS signal and said estimated harmonic distortion sample, and then calculate with respect to said error signal so as to obtain at least one weight value, said weight value being used to adjust operational coefficients of said harmonic distortion predictor so as to adjust said estimated harmonic distortion sample.

6. The apparatus according to claim 5, wherein said minimum error algorithmic unit is capable of executing the process of minimum error algorithm repeatedly until said error signal converges.

7. The apparatus according to claim 5, wherein said minimum error algorithmic unit is a least mean square (LMS) algorithmic unit, a mean square error (MSE) algorithmic unit, a recursive least square (RLS) algorithmic unit, or an algorithmic unit used for minimizing error signal.

8. The apparatus according to claim 1, further comprising a digital estimating algorithmic unit, connected to said GPS signal reception path and said harmonic distortion predictor, wherein said digital estimating algorithmic unit is allowed for estimating output energy or signal variation of said digital GPS signal so as to obtain an estimating signal, said estimating signal being used to adjust operational coefficients of said harmonic distortion predictor so as to adjust said estimated harmonic distortion sample.

9. The apparatus according to claim 8, wherein said digital estimating algorithmic unit is a minimum output energy (MOE) algorithmic unit or a minimum variance unbiased (MVU) estimating algorithmic unit.

10. The apparatus according to claim 1, wherein said harmonic distortion predictor is a Volterra digital filter, an adaptive digital filter, or a digital filter capable of generating said estimated harmonic distortion sample digitally.

11. The apparatus according to claim 1, wherein said RF transceiver module is connected to a first antenna, said RF transceiver module communicating with a base station wirelessly via said first antenna, and said GPS signal reception path is connected to a second antenna, said GPS signal reception path receiving said analog GPS signal transmitted by a satellite via said second antenna.

12. The apparatus according to claim 1, wherein an antenna is shared by said RF transceiver module and said GPS signal reception path, said RF transceiver module communicating with a base station wirelessly via said antenna, while said GPS signal reception path receiving said analog GPS signal transmitted by a satellite via said antenna.

13. The apparatus according to claim 12, wherein said RF transceiver module and said GPS signal reception path are connected to said antenna via a duplexer.

14. A method for reducing harmonic interference to GPS signal reception, said method being applied to GPS signal reception of a wireless communication device, comprising the steps of:
executing a process of establishing an estimated harmonic distortion sample, comprising:
generating a first signal to be transmitted; and
inputting said first signal to a harmonic distortion predictor so as to establish an estimated harmonic distortion sample digitally; and
executing a process of GPS signal reception, comprising:
receiving an analog GPS signal;
converting said analog GPS signal into a digital GPS signal; and
subtracting said estimated harmonic distortion sample from said digital GPS signal in digital domain digitally, so as to reduce distortion of said digital GPS signal.

15. The method according to claim 14, wherein executing said process of establishing said estimated harmonic distortion sample further comprises a step of:
testing on a surface acoustic wave filter in a GPS signal reception path for characteristics, so as to verify at least one characteristic parameter of said surface acoustic wave filter.

16. The method according to claim 15, wherein executing said process of establishing said estimated harmonic distortion sample further comprises a step of:
inputting said first signal and said characteristic parameter of said surface acoustic filter to said harmonic distortion predictor, so as to establish said estimated harmonic distortion sample digitally.

17. The method according to claim 14, wherein executing said process of establishing said estimated harmonic distortion sample further comprises executing a process of minimum error algorithm, comprising:
acquiring an error signal between said digital GPS signal and said estimated harmonic distortion sample;
calculating with respect to said error signal by means of a minimum error algorithm so as to obtain a weight value; and
adjusting operational coefficients of said harmonic distortion predictor by the use of said weight value, so as to adjust said estimated harmonic distortion sample.

18. The method according to claim 17, wherein said process of minimum error algorithm is executed repeatedly until said error signal converges.

19. The method according to claim 17, wherein said minimum error algorithm is a least mean square (LMS) algorithm, a mean square error (MSE) algorithm, a recursive least square (RLS) algorithm, or an algorithm used for minimizing error signal.

20. The method according to claim 14, wherein executing said process of establishing said estimated harmonic distortion sample further comprises executing a process of digital estimating algorithm, comprising:
estimating output energy or signal variation of said digital GPS signal so as to obtain an estimating signal by means of a digital estimating algorithm; and
adjusting operational coefficients of said harmonic distortion predictor so as to adjust said estimated harmonic distortion sample by the use of said estimating signal.

21. The method according to claim 20, wherein said digital estimating algorithm is a minimum output energy (MOE) algorithm or a minimum variance unbiased (MVU) estimating algorithm.

22. The method according to claim 14, wherein said harmonic distortion predictor is a Volterra digital filter, an adaptive digital filter, or a digital filter capable of generating said estimated harmonic distortion sample digitally.
